(19) United States
(12) Patent Application Publication
(10) Pub. No.: US 2014/0055006 A1
(43) Pub. Date: Feb. 27, 2014

(54) VIBRATION GENERATION DEVICE

(71) Applicant: SAMSUNG ELECTRO-MECHANICS CO., LTD., Gyunggi-do (KR)

(72) Inventors: Hwa Young OH, Gyunggi-do (KR); Dong Sun PARK, Gyunggi-do (KR)

(73) Assignee: Samsung Electro-Mechanics Co., LTD., Gyunggi-do (KR)

(21) Appl. No.: 13/683,379

(22) Filed: Nov. 21, 2012

(30) Foreign Application Priority Data
Aug. 23, 2012 (KR) 10-2012-0092185

(51) Int. Cl. H02N 2/00

(52) U.S. Cl. CPC H02N 2/001
USPC 310/329

(57) ABSTRACT

There is provided a vibration generation device. The vibration generation device may include a housing including an internal space; a piezoelectric actuator mounted in the housing to be disposed in the internal space and including a piezoelectric element deformed in a horizontal direction; a direction conversion member fixed to the piezoelectric actuator; and a vibrator disposed in the internal space while being fixed to the direction conversion member, and displaced in a vertical direction due to a deformation of the piezoelectric actuator in the horizontal direction.

### CROSS-REFERENCE TO RELATED APPLICATIONS

This application claims the priority of Korean Patent Application No. 10-2012-0092185 filed on Aug. 23, 2012, in the Korean Intellectual Property Office, the disclosure of which is incorporated herein by reference.

### BACKGROUND OF THE INVENTION

1. Field of the Invention

The present invention relates to a vibration generation device.

2. Description of the Related Art

A vibration generation device, a component that converts electrical energy into mechanical vibrations using an electromagnetic force generation principle, is mounted in a cellular phone to be used for silently informing a user of call receipt.

Further, there is a growing demand for multi-functional cellular phones as a market thereof rapidly expands. Since a demand for small and high-quality cellular phone components is increasing according to this tendency, demand for development of a vibration generation device having a structure capable of remarkably improving quality while improving disadvantages inherent in existing products has increased.

As cellular phones having large LCD screens have increasingly been released in recent years, a vibration generation device for generating vibrations at the time of a touch has been adopted due to the use of a touchscreen.

First, the vibration generation device used in a cellular phone in which a touchscreen is adopted is more frequently used for the generation of vibrations than merely at the time of call reception, and therefore, the operational lifespan of the vibration generation device needs to be increased. Second, the vibration generation device needs to have a rapid response speed, able to keep pace with a speed of a user touching a touchscreen.

A cellular phone currently adopting a touchscreen uses a linear vibrator according to the demand for a long lifespan and rapid responsiveness.

The linear vibrator does not use a rotational principle of a motor, but may linearly resonate a mover hung from a spring by electromagnetic force of a coil and a magnet using a mass body connected toto an elastic member mounted in the vibration generation device to generate vibrations.

Further, it is possible to generate vibrations by linearly resonating a mover according to the contraction and expansion of a piezoelectric element used as an actuator.

In addition, a spring has generally been used as the elastic member. Here, as the spring, a leaf spring, a coil spring, and the like, has been used. However, the lifespan of the spring may be limited due to a rupture thereof. Further, when physical properties of the spring are changed due to surrounding environmental conditions, and the like, the spring may be more easily ruptured.

In addition, vibration may be weakened or noise may occur, at the time of generating vibrations in an abnormal mode (torsion, left and right shaking, and the like) of the spring.

### SUMMARY OF THE INVENTION

An aspect of the present invention provides a vibration generation device allowing for rapid responsiveness using an elastic member having a linear shape while using a piezoelectric element as an actuator.

According to an aspect of the present invention, there is provided a vibration generation device including: a housing including an internal space; a piezoelectric actuator mounted in the housing to be disposed in the internal space and including a piezoelectric element deformed in a horizontal direction; a direction conversion member fixed to the piezoelectric actuator; and a vibrator disposed in the internal space while being fixed to the direction conversion member, and displaced in a vertical direction due to a deformation of the piezoelectric actuator in the horizontal direction.

The direction conversion member may include at least two elastic members extending in the horizontal direction from inner ends thereof to which the vibrator is fixed and having outer ends thereof fixed to the piezoelectric actuator, and the inner ends of the elastic members may be disposed above the outer ends thereof in the vertical direction.

The at least two elastic members may be disposed in the same air gap or may be disposed to be symmetrical with respect to each other in the horizontal direction.

The at least two elastic members may have the same length.

The direction conversion member may further include a vibrator mounting member disposed on the inner ends of the elastic members and fixing the vibrator.

The vibrator mounting member may be disposed at a center of the at least two elastic members in the state in which the at least two elastic members are disposed.

The direction conversion member may further include a stator mounting member extending downwardly in the vertical direction from the outer ends of the elastic members, and the stator mounting member may be fixed to the piezoelectric actuator.

The stator mounting member may be provided to be bent from the outer ends of the elastic members.

The stator mounting member may be vertically joined to a main surface of the piezoelectric actuator.

The stator mounting member may have a plate shape.

The stator mounting member may have a surface vertically mounted with respect to the direction in which the piezoelectric actuator is deformed.

The direction conversion member may further include a bottom opposing member extending in the horizontal direction from a distal end of the stator mounting member.

A distance between the outer ends of at least two elastic members may be 10 or more times and 1000 or less times a distance between the direction conversion member and the piezoelectric actuator.

The housing may include a bracket on which the piezoelectric actuator is mounted and a case covering the bracket and integrated with the bracket to provide the internal space.

The vibration generation device may further include: a substrate attached to the bracket to be located in the internal space and supplying power to the piezoelectric actuator.

An air gap between the vibrator and the housing may be larger than an air gap between the piezoelectric actuator and a member disposed on a top portion of the piezoelectric actuator in the vertical direction.

The member disposed on the top portion of the piezoelectric actuator may be the direction conversion member.

The vibrator may be a weight formed of a high-density material.

The weight may be provided to be longer than the piezoelectric actuator in the horizontal direction.

The weight may include a weight adding part extending downwardly in the vertical direction from an outer end of the piezoelectric actuator.

At least one of the vibrator and an inner surface of the housing, opposing thereto may include a damper.

The damper may be disposed on an outer end of the vibrator or the inner surface of the housing, opposing thereto.

The damper may be formed of a material including at least one of urethane foam, silicon foam, and rubber.

The damper may be elastomer and may be formed of a noise absorbing material.

The vibration generation device may further include: an additional elastic member having one end fixed to the vibrator and the other end fixed to the housing.

The additional elastic member may be at least one coil spring or at least one leaf spring.

The piezoelectric element may have a square pillar shape in which a length thereof in the horizontal direction is greater than a height thereof in the vertical direction.

The housing may have a square pillar shape in which a length thereof in the horizontal direction is greater than a height thereof in the vertical direction.

According to another aspect of the present invention, there is provided a vibration generation device including: a housing including an internal space; a piezoelectric actuator mounted in the housing to be disposed in the internal space and including a piezoelectric element deformed in a predetermined direction; an elastic member having one end fixed to the piezoelectric actuator and having a length varied in a direction vertical to the predetermined direction, by a deformation of the piezoelectric actuator in the predetermined direction; and a vibrator fixed to the other end of the elastic member and vibrating in the direction vertical to the predetermined direction.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view of a vibration generation device according to an embodiment of the present invention;

FIG. 2 is a combined perspective view of the vibration generation device according to the embodiment of the present invention;

FIG. 3 is an exploded perspective view of the vibration generation device according to the embodiment of the present invention;

FIGS. 4A and 4B are explanatory diagrams showing an operation of the vibration generation device according to the embodiment of the present invention; and

FIGS. 5, 6A, 6B, 7A and 7B are schematic cross-sectional views, each showing a vibration generation device according to another embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

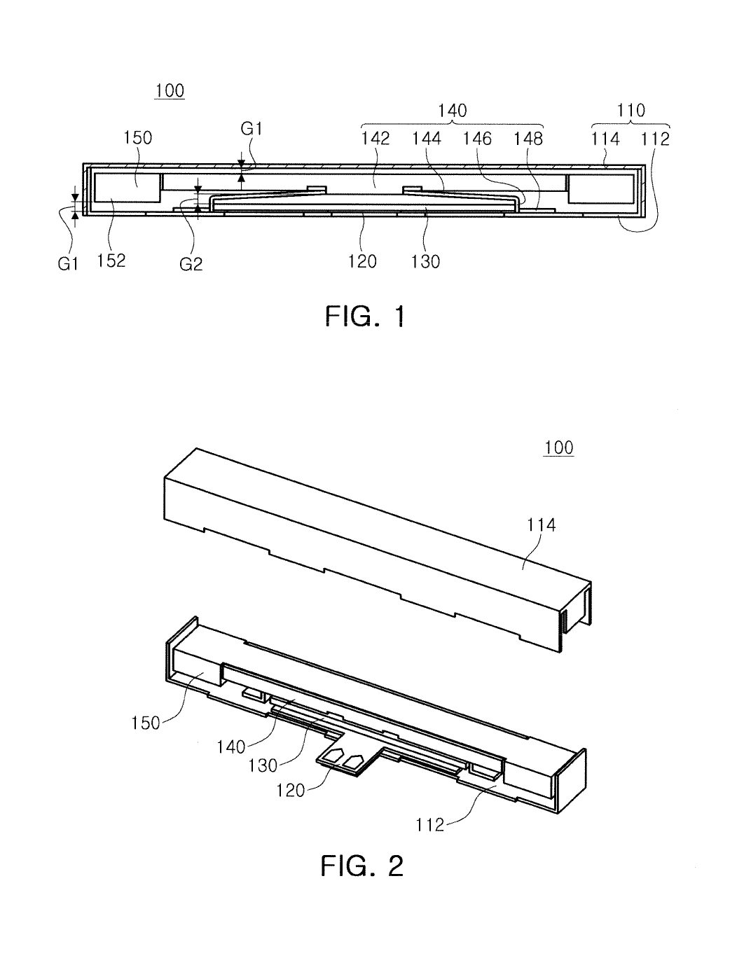

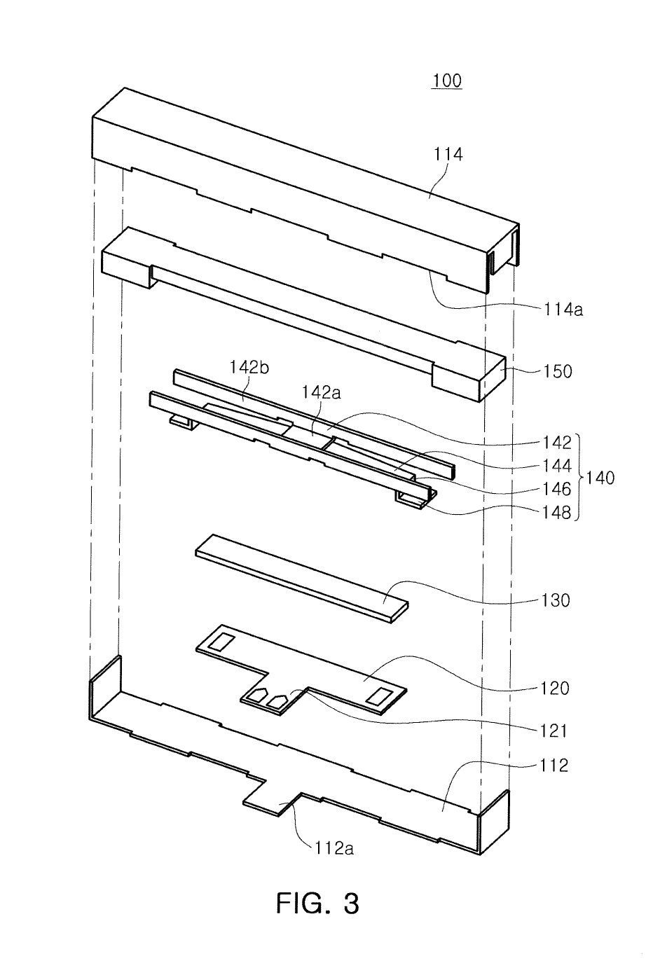

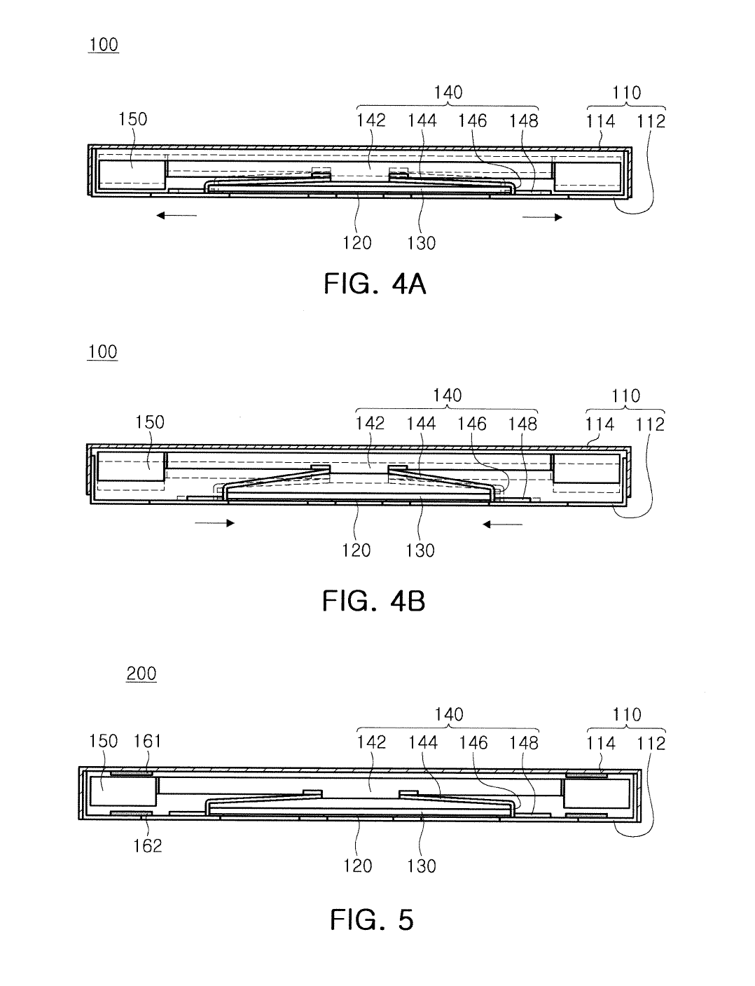

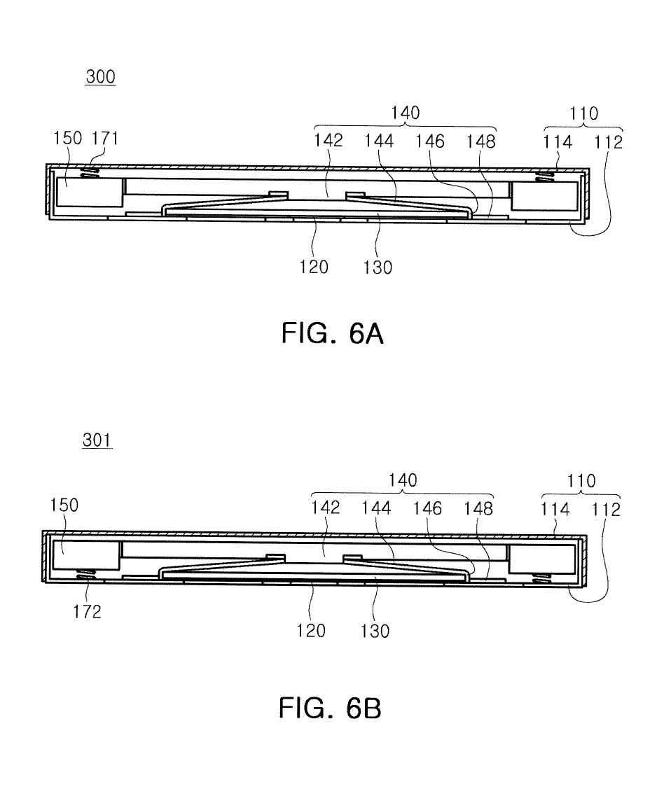

FIG. 1 is a schematic cross-sectional view of a vibration generation device according to an embodiment of the present invention, FIG. 2 is a combined perspective view of the vibration generation device according to the embodiment of the present invention, FIG. 3 is an exploded perspective view of the vibration generation device according to the embodiment of the present invention, and FIGS. 4A and 4B are explanatory diagrams showing an operation of the vibration generation device according to the embodiment of the present invention.

Referring to FIGS. 1 through 4, a vibration generation device 100 according to an embodiment of the present invention may include a housing 110 forming an exterior of the vibration generation device 100, a substrate 120 for supplying power, a piezoelectric actuator 130 contracted and expanded in a horizontal direction due to a supply of power, a direction conversion member 140 fixed to the piezoelectric actuator 130, and a vibrator (weight) 150 displaced in a vertical direction due to a deformation of the piezoelectric actuator 130 in the horizontal direction.

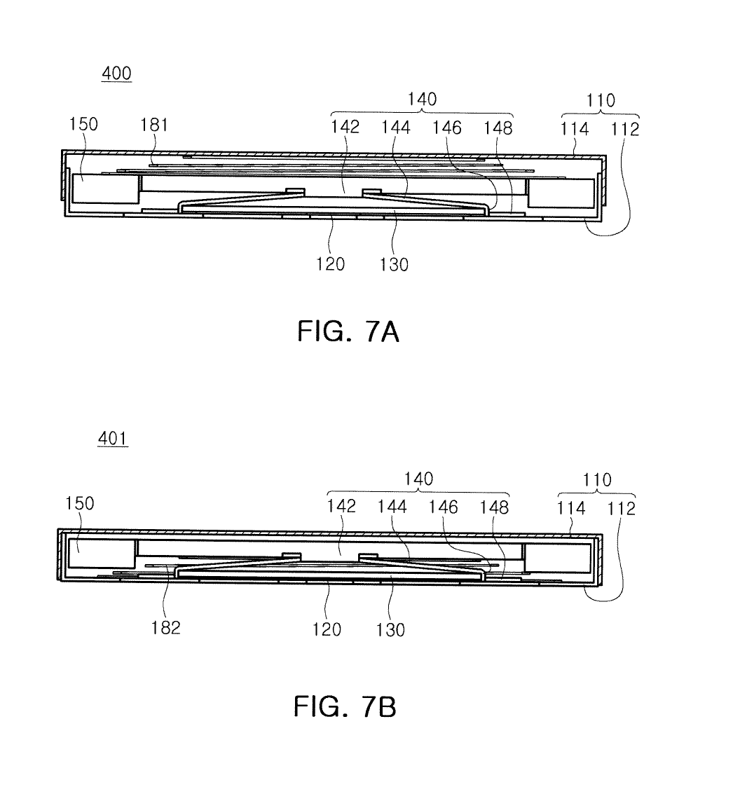

In addition, although described with reference to FIGS. 5 through 7, the vibration generation device may optionally include dampers 161 and 162, coil springs 171 and 172, leaf springs 181 and 182, and the like.

First, when defining terms related to directions, a horizontal direction may mean a left and right direction in FIG. 1, that is, a direction (that is, a length direction) from one end of the actuator 130 or the vibrator 150 toward the other end and a vertical direction may mean a top and bottom direction in FIG. 1, that is, a direction (a thickness direction) toward a top surface from a bottom surface of the piezoelectric actuator 130 or the vibrator 150. However, the horizontal direction does not refer to a specific direction and if a direction is toward the right from the left or toward the left from the right, the direction may be considered to be a horizontal direction. If a direction is provided to be vertical to the horizontal direction, the direction may be considered to be a vertical direction.

In addition, a main surface may be the widest surface in a predetermined member, for example, the piezoelectric actuator 130 or the vibrator 150.

Further, an outer side of a predetermined member may mean a left and right direction as a horizontal direction based on a center of the vibrator 150, but an inner side of a predetermined member may mean a direction towards an approximate center of the vibrator 150 from the left and right thereof in the horizontal direction.

The housing 110 has an internal space and forms an exterior of the vibration generation device 100. The housing 110 may include a bracket 112 and a case 114. The bracket 112 may have the piezoelectric actuator 130 mounted thereabove, to be described below. Further, after the substrate is first mounted on the bracket 112, the piezoelectric actuator 130 may be mounted on a top portion of the substrate 120. Further, the case 114 covers the bracket 112 and may be integrated with the bracket 112 to provide the internal space.

Here, the embodiment of the present invention illustrates a shape in which the substrate 120 or the actuator 130 is mounted on the bracket 112, but the substrate 120 or the piezoelectric actuator 130 may be fixed to the case 114.

The bracket 112 may have a ‘ [symbol] ’-shape so that a member may be easily mounted therein. Further, a bottom surface of the case 114 may have an opened box shape, that is, a hexahedral shape so that the case 114 generally covers the bracket 112.

Further, the shape of the bracket 112 or the case 114 is not limited thereto and therefore, may be varied. For example, the bracket may be formed as a circular plate and the case may have a cylindrical shape providing an internal space by covering the circular plate.

The substrate 120 may be fixed to the bracket 112. The substrate 120 may be mounted on an inner surface of the housing 110 and on an outer surface of the housing 110 to be located in the internal space of the housing 110. The substrate 120 may be a printed circuit board. Hereinafter, the case in which the substrate 120 is mounted on the inner surface of the housing 110 will be described, by way of an example.

Further, when the substrate 120 is mounted on the inner surface of the housing 110, the substrate may include a terminal connection part 121 exposed to the outside of the housing 110.

Therefore, the housing 110 may be provided with a through hole 114a so that the terminal connection part 121 is exposed to the outside. In particular, the case 114 may be provided with the through hole 114a. Further, the bracket 112 may be provided with a terminal support 121 protruding to the outside from a position of the bracket 112, corresponding to a position of the through hole 114a, and the terminal connection part 121 may be extended on a top surface of the terminal support 112a.

The top surface of the substrate 120 may have the piezoelectric actuator 130 mounted thereabove, to be described below. That is, the piezoelectric actuator 130 may be mounted to be located in the internal space of the housing 110. The piezoelectric actuator 130 may be mounted to be extended in the horizontal direction.

The piezoelectric actuator 130 may include an electrode and a piezoelectric element. When power is applied to the electrode, the piezoelectric element may be repeatedly expanded and contracted in the horizontal direction.

The piezoelectric element may be formed of a piezoelectric material, preferably, a lead zirconate titanate (PZT) ceramic material, and the like. However, the piezoelectric element is not limited thereto.

The piezoelectric actuator 130 may have the direction conversion member 140 mounted thereon. A top portion of the direction conversion member 140 may have the vibrator (weight) 150 mounted thereon, to be described below. The direction conversion member 140 may allow the vibrator 150 that is mounted on the top portion thereof, to be displaced in the vertical direction according to a deformation (expansion or contraction) of the piezoelectric actuator 130 in the horizontal direction.

The direction conversion member 140 extends in the horizontal direction from an inner end thereof to which the vibrator 150 is fixed and the outer end thereof may be provided with at least two elastic members 144 fixed to the piezoelectric actuator 130. Therefore, the inner ends of at least two elastic members 144 may be provided to be connected to each other or be indirectly connected to each other by the vibrator 150.

The elastic member 144 may be provided so that the inner end thereof is disposed above the outer end thereof in the vertical direction. Further, at least two elastic members 144 may be disposed in the same air gap or may be disposed to be symmetrical with respect to each other in the horizontal direction.

In the embodiment of the present invention, the vibrator 150 that is extended in the length direction is provided and therefore, the elastic member 144 may be provided to be symmetrical left and right based on the center of the vibrator 150 in the horizontal direction. Further, at least two elastic members 144 may be disposed to be symmetrical left and right based on the center of the vibrator 150. In this case, the number of elastic members 144 that are disposed left may be identical to the number of the elastic members 144 disposed right, and the elastic members 144 that are respectively disposed left and right may have the same air gap. That is, the same support force (or elastic force) may be generated left and right.

However, the shape of the elastic member 144 is not limited thereto and therefore, the elastic member 144 may be disposed in various shapes. For example, when the vibrator 150 is provided in a circular shape, the plurality of elastic members 144 may be disposed such that the outer ends thereof respectively extend radially in the state in which the inner ends thereof are fixed to the center of the vibrator 150. Therefore, at least two elastic members 144 may be provided to have the same length.

The elastic members 144 may be provided as at least two elastic members 144 and may be disposed such that the inner ends thereof are disposed above the outer ends thereof, wherein the outer ends of the elastic members 144 may be mounted on the piezoelectric actuator 130.

In this state, when the piezoelectric actuator 130 is expanded and contracted in the horizontal direction, the outer end of the elastic member 144 is displaced outwardly or inwardly in the horizontal direction. Therefore, at least two elastic members 144 are provided and the inner ends of the elastic members 144 that are directly or indirectly connected to each other may be displaced downwardly or upwardly in the vertical direction. Therefore, the vibrator 150 mounted on the inner ends of the elastic members 144 may be vibrated upwardly or downwardly in the vertical direction.

Describing in more detail with reference to the drawings, FIG. 4A illustrates a shape in which the piezoelectric actuator 130 is expanded in the horizontal direction and FIG. 4B illustrates a shape in which the piezoelectric actuator 130 is contracted in the horizontal direction.

Referring to FIG. 4A, as the piezoelectric actuator 130 is expanded in the horizontal direction, the outer ends of at least two elastic members 144 fixed to the piezoelectric actuator 130 may move outwardly. Therefore, the inner ends of at least two elastic members 144 that are directly or indirectly connected to each other may be displaced downwardly in the vertical direction. Therefore, the vibrator 150 mounted on the inner ends of the elastic members 114 may be displaced downwardly in the vertical direction.

Referring to FIG. 4B, as the piezoelectric actuator 130 is contracted in the horizontal direction, the outer ends of at least two elastic members 144 fixed to the piezoelectric actuator 130 may move inwardly. Therefore, the inner ends of at least two elastic members 144 that are directly or indirectly connected to each other may be displaced upwardly in the vertical direction. Therefore, the vibrator 150 mounted on the inner ends of the elastic members 144 may be displaced upwardly in the vertical direction.

As shown in FIGS. 4A and 4B, as the piezoelectric actuator 130 is repeatedly expanded or contracted in the horizontal direction, the vibrator 150 mounted on the inner ends of the elastic members 144 may be vibrated downwardly or upwardly in the vertical direction.

Meanwhile, the direction conversion member 140 may further include a vibrator mounting member 142 located at the inner end of the elastic member 144 and allowing the vibrator 150 to be fixed. The vibrator mounting member 142 may include a support plate 142a fixed to the inner end of the elastic member 144 and side plates 142b respectively protruding vertically from both sides of the support plate 142a. Therefore, a bottom surface of the vibrator 150 is supported by the support plate 142a and the side thereof may be fixed to the vibrator mounting member 142 in the state in which the vibrator 150 is supported by the side plates 142b. Here, the inner end of the elastic member 144 may also act as the support plate 142a.

Further, the direction conversion member 140 may further include a stator mounting member 146 extending downwardly in the vertical direction from the outer end of the elastic member 144 and the stator mounting member 146 may be fixed to the piezoelectric actuator 130. The stator mounting member 146 is provided to be bent from the outer end of the elastic member 144 or may be attached with a separate member.

Here, the stator mounting member 146 may be vertically joined to the main surface (top surface) of the piezoelectric actuator 130. In particular, the inner surface of the stator mounting member 146 may be fixed to be attached to the outer side of the piezoelectric actuator 130.

To this end, the stator mounting member 146 is provided to have a plate shape and the stator mounting member 146 may have a surface vertically mounted with respect to the direction in which the piezoelectric actuator 130 is deformed.

Therefore, when the stator mounting member 146 is displaced in the horizontal direction by the piezoelectric actuator 130, the direction conversion is largely generated at a portion at which the elastic member 144 is connected to the stator mounting member 146 to further increase the vertical displacement of the inner end of the elastic member 144.

The direction conversion member 146 may further include a bottom opposing member 148 extending in the horizontal direction from a distal end of the stator mounting member 146. The bottom opposing member 148 may act to guide the horizontal displacement of the direction conversion member 146.

Further, a distance between the outer ends of at least two elastic members 144 may be provided to be 10 or more times to 1000 or less times shorter than a distance between the direction conversion member 140 and the piezoelectric actuator 130. That is, a ratio of the vertical displacement of the vibrator 150 to the horizontal deformation of the piezoelectric actuator 130 may be in a range of 1:10 to 1:1000.

Here, the distance (air gap) between the direction conversion member 140 and the piezoelectric actuator 130 may be an air gap between the top surface of the piezoelectric actuator 130 and the bottom surface of the inner end of the elastic member 144.

The top portion of the direction conversion member 146 may have the vibrator 150 disposed thereon. The vibrator 150 may be a weight made of a high-density material. The vibrator 150 may be formed of copper-based materials such as brass or a tungsten-based materials.

The vibrator 150 may be disposed lengthily in the horizontal direction. That is, the vibrator 150 is disposed to be longer than the piezoelectric actuator 130 in the horizontal direction and may include a portion that is protruded outwardly from the outer end of the piezoelectric actuator 130.

The vibrator 150 may include a weight adding part 152 extending downwardly in the vertical direction from the outer end of the piezoelectric actuator 130. The weight adding part 152 may be integrally provided with the vibrator 150 and may be separately provided from the vibrator 150.

Further, an air gap G1 between the vibrator 150 and the housing 110 may be provided to be larger than an air gap G2 between the piezoelectric actuator 130 and a member disposed above the piezoelectric actuator 130. The member disposed above the piezoelectric actuator 130 may be the direction conversion member 140. In more detail, the member may be the inner end of the elastic member 144.

The vibrator 150 is a member that is vibrated in the internal space of the housing 110 and therefore, does not preferably contact the inner surface of the housing 110 during the vibrating of the vibrator 150. Therefore, the air gap G1 between the vibrator 150 and the housing 110 may be provided to be smaller than the air gap G2 between the piezoelectric actuator 130 and the member disposed above the piezoelectric actuator 130, corresponding to the maximum distance in which the vibrator 150 may be vibrated.

Here, the air gap G1 between the vibrator 150 and the housing 110 may be an air gap between the vibrator 150 and the inner surface of the case 114 or an air gap between the vibrator 150 and the inner surface of the bracket 112.

FIGS. 5, 6A, 6B, 7A and 7B are schematic cross-sectional views, each showing a vibration generation device according to another embodiment of the present invention. Hereinafter, members that may be additionally included in the vibration generation device 100 according to the embodiment of the present invention described with reference to FIGS. 1 through 4 will be described. Hereinafter, only components different from the vibration generation device 100 according to the embodiment of the present invention described with reference to FIGS. 1 to 4 are described and the remaining components may be substituted with the foregoing description.

Referring to FIG. 5, a vibration generation device 200 according to another embodiment of the present invention may include the dampers 161 and 162 that are mounted on the inner surface of the housing 110. That is, the vibrator 150 may be disposed in the internal space of the housing 110 and thus, is vibrated in the vertical direction, such that the vibrator 150 may contact the inner surface of the housing 110 upwardly and downwardly in the vertical direction.

Therefore, the inner surface of the housing 110 may have the dampers 161 and 162 provided in the vertical direction.

FIG. 5 only illustrates the case in which the damper is provided on the inner surface of the housing 110, but the damper may also be provided on the top surface or the bottom surface of the vibrator 150 in the vertical direction.

In particular, the dampers 161 and 162 may be disposed on the outer end of the vibrator 150 or the inner surface of the housing 110, opposing thereto.

The dampers 161 and 162 may be elastomer and may be formed of a material including at least one of urethane foam, silicon foam, and rubber so as to absorb noise. In particular, the dampers 161 and 162 may be formed of PORON®.

Referring to FIGS. 6A and 6B, vibration generation devices 300 and 301 according to another embodiment of the present invention may include an additional elastic member that is mounted between the inner surface of the housing 110 and the vibrator 150.

The additional elastic member may be the coil springs 171 and 172. At least one of the coil springs 171 and 172 may be mounted between the outer end of the vibrator 150 and the inner surface of the housing 110, opposing thereto.

The coil spring 171 may be provided between the top surface of the vibrator 150 and the ceiling surface (case 114) of the housing 110 or the coil spring 172 may be provided between the bottom surface of the vibrator 150 and the bottom surface (bracket 112) of the housing 110.

The additional elastic member may add vibratory force to the vibrator 150, in addition to vibrations generated by the piezoelectric actuator 130.

Referring to FIGS. 7A and 7B, vibration generation devices 400 and 401 according to another embodiment of the present invention may include an additional elastic member that is mounted between the inner surface of the housing 110 and the vibrator 150.

The additional elastic member may be leaf springs 181 and 182. The leaf springs 181 and 182 may be mounted between the vibrator 150 and the inner surface of the housing 110, opposing thereto.

The leaf spring 181 may be provided between the top surface of the vibrator 150 and the ceiling surface (case 114) of the housing 110 or the leaf spring 182 may be provided between the bottom surface of the vibrator 150 and the bottom surface (bracket 112) of the housing 110.

Meanwhile, when the leaf spring 181 is provided between the bottom surface of the vibrator 150 and the bottom surface (bracket 112) of the housing 110, a center of the leaf spring 181 approximately coincides with the center of the vibrator 150 and may be formed to enclose the piezoelectric actuator 130 and the direction conversion member 140.

The additional elastic member may add vibratory force to the vibrator 150, in addition to the vibrations generated by the piezoelectric actuator 130.

As set forth above, according to the embodiments of the present invention, it is possible to provide a vibration generation device allowing for rapid responsiveness using an elastic member having a linear shape while using a piezoelectric element as an actuator.

While the present invention has been shown and described in connection with the embodiments, it will be apparent to those skilled in the art that modifications and variations can be made without departing from the spirit and scope of the invention as defined by the appended claims.

What is claimed is:

1. A vibration generation device, comprising:
a housing including an internal space;
a piezoelectric actuator mounted in the housing to be disposed in the internal space and including a piezoelectric element deformed in a horizontal direction;
a direction conversion member fixed to the piezoelectric actuator; and
a vibrator disposed in the internal space while being fixed to the direction conversion member, and displaced in a vertical direction due to a deformation of the piezoelectric actuator in the horizontal direction.

2. The vibration generation device of claim 1, wherein the direction conversion member includes at least two elastic members extending in the horizontal direction from inner ends thereof to which the vibrator is fixed and having outer ends thereof fixed to the piezoelectric actuator, and
the inner ends of the elastic members are disposed above the outer ends thereof in the vertical direction.

3. The vibration generation device of claim 2, wherein the at least two elastic members are disposed in the same air gap or are disposed to be symmetrical with respect to each other in the horizontal direction.

4. The vibration generation device of claim 2, wherein the at least two elastic members have the same length.

5. The vibration generation device of claim 2, wherein the direction conversion member further includes a vibrator mounting member disposed on the inner ends of the elastic members and fixing the vibrator.

6. The vibration generation device of claim 5, wherein the vibrator mounting member is disposed at a center of the at least two elastic members in the state in which the at least two elastic members are disposed.

7. The vibration generation device of claim 2, wherein the direction conversion member further include a stator mounting member extending downwardly in the vertical direction from the outer ends of the elastic members, and
the stator mounting member is fixed to the piezoelectric actuator.

8. The vibration generation device of claim 7, wherein the stator mounting member is provided to be bent from the outer ends of the elastic members.

9. The vibration generation device of claim 7, wherein the stator mounting member is vertically joined to a main surface of the piezoelectric actuator.

10. The vibration generation device of claim 7, wherein the stator mounting member has a plate shape.

11. The vibration generation device of claim 10, wherein the stator mounting member has a surface vertically mounted with respect to the direction in which the piezoelectric actuator is deformed.

12. The vibration generation device of claim 7, wherein the direction conversion member further includes a bottom opposing member extending in the horizontal direction from a distal end of the stator mounting member.

13. The vibration generation device of claim 2, wherein a distance between the outer ends of at least two elastic members is 10 or more times and 1000 or less times a distance between the direction conversion member and the piezoelectric actuator.

14. The vibration generation device of claim 1, wherein the housing includes a bracket on which the piezoelectric actuator is mounted and a case covering the bracket and integrated with the bracket to provide the internal space.

15. The vibration generation device of claim 1, further comprising a substrate attached to the bracket to be located in the internal space and supplying power to the piezoelectric actuator.

16. The vibration generation device of claim 1, wherein an air gap between the vibrator and the housing is larger than an air gap between the piezoelectric actuator and a member disposed on a top portion of the piezoelectric actuator in the vertical direction.

17. The vibration generation device of claim 16, wherein the member disposed on a top portion of the piezoelectric actuator is the direction conversion member.

18. The vibration generation device of claim 1, wherein the vibrator is a weight formed of a high-density material.

19. The vibration generation device of claim 18, wherein the weight is provided to be longer than the piezoelectric actuator in the horizontal direction.

20. The vibration generation device of claim 19, wherein the weight includes a weight adding part extending downwardly in the vertical direction from an outer end of the piezoelectric actuator.

21. The vibration generation device of claim 1, wherein at least one of the vibrator and an inner surface of the housing, opposing thereto includes a damper.

22. The vibration generation device of claim 21, wherein the damper is disposed on an outer end of the vibrator or the inner surface of the housing, opposing thereto.

23. The vibration generation device of claim 21, wherein the damper is formed of a material including at least one of urethane foam, silicon foam, and rubber.

24. The vibration generation device of claim 21, wherein the damper is elastomer and is formed of a noise absorbing material.

25. The vibration generation device of claim 1, further comprising an additional elastic member having one end fixed to the vibrator and the other end fixed to the housing.

26. The vibration generation device of claim 25, wherein the additional elastic member is at least one coil spring or at least one leaf spring.

27. The vibration generation device of claim 1, wherein the piezoelectric element has a square pillar shape in which a length thereof in the horizontal direction is greater than a height thereof in the vertical direction.

28. The vibration generation device of claim 27, wherein the housing has a square pillar shape in which a length thereof in the horizontal direction is greater than a height thereof in the vertical direction.

29. A vibration generation device, comprising:
a housing including an internal space;
a piezoelectric actuator mounted in the housing to be disposed in the internal space and including a piezoelectric element deformed in a predetermined direction;
an elastic member having one end fixed to the piezoelectric actuator and having a length varied in a direction vertical to the predetermined direction, by a deformation of the piezoelectric actuator in the predetermined direction; and
a vibrator fixed to the other end of the elastic member and vibrating in the direction vertical to the predetermined direction.
